(19) United States
(12) Patent Application Publication
(10) Pub. No.: US 2015/0272017 A1
(43) Pub. Date: Oct. 1, 2015

(54) METHOD AND SYSTEM FOR AUTOMATED DIFFERENTIAL IRRIGATION

(71) Applicant: LANDCARE RESEARCH NEW ZEALAND LIMITED, Lincoln (NZ)

(72) Inventors: Carolyn Betty Hedley, Palmerston North (NZ); Jagath Chandralal Ekanayake, Christchurch (NZ); Pierre Roudier, Palmerston North (NZ); Itzhak Bentwich, Nelson (NZ)

(73) Assignee: LANDCARE RESEARCH NEW ZEALAND LIMITED, Lincoln (NZ)

(21) Appl. No.: 14/440,950

(22) PCT Filed: Nov. 6, 2013
(86) PCT No.: PCT/NZ2013/000197

§ 371 Date: May 6, 2015

(30) Foreign Application Priority Data
Nov. 6, 2012 (NZ) 603449

(51) Int. Cl. A01G 25/16; G05B 15/02

(52) U.S. Cl. CPC A01G 25/16; G05B 15/02

(57) ABSTRACT

The present invention discloses an automated method for optimizing irrigation, whereby different parts of a field are irrigated different amounts, based at least in part on an analysis of spatial soil properties of the field, and extrapolation of data from soil sensors placed in the different parts of a field.

### FIELD OF THE INVENTION

The present invention relates to the field of agricultural irrigation.

### BACKGROUND OF THE INVENTION

Various systems for automated agricultural irrigation are known.

### SUMMARY OF THE INVENTION

In various preferred embodiments, the present invention provides a method for reducing the amount of water required to irrigate an agriculture field, by applying different amounts of water to different parts of the field, based at least in part on an analysis of spatial soil properties of the field including topological features, and extrapolation of data from soil sensors placed in different parts of a field.

According to a preferred embodiment of the present invention provides a computerized differential irrigation system comprising:

a computerized Topography Integrated Ground watEr Retention (TIGER) map generator receiving at least the following inputs:

a topographical input describing topographical features of an area to be irrigated; and

an electromagnetic input describing conductive features of the area to be irrigated,

and in which the computerized Topography Integrated Ground watEr Retention (TIGER) map generator includes:

a computerized topographic feature processing functionality providing information relating to at least one of slope, aspect and catchment area features of said area to be irrigated; and

a computerized topographic feature utilization functionality employing at least one of slope, aspect and catchment area features of the area to be irrigated for automatically ascertaining water retention at a plurality of different regions within the area to be irrigated; and

a computerized computing functionality employing the Topography Integrated Ground watEr Retention (TIGER) map together with at least current outputs of wetness sensors located at the plurality of different regions within the area to be irrigated to generate a current irrigation plan; and

a computerized irrigation control subsystem automatically utilizing the current irrigation map to control irrigation within the area to be irrigated based on the current irrigation instructions and to cause different amounts of water to be provided to the different regions within the area to be irrigated.

The invention also provides a computerized irrigation planning system comprising:

a computerized Topography Integrated Ground watEr Retention (TIGER) map generator receiving at least the following inputs:

a topographical input describing topographical features of an area to be irrigated; and

an electromagnetic input describing conductive features of the area to be irrigated,

and in which the computerized Topography Integrated Ground watEr Retention (TIGER) map generator includes:

a computerized topographic feature processing functionality providing information relating to at least one of slope, aspect and catchment area features of the area to be irrigated; and

a computerized topographic feature utilization functionality employing the at least one of slope, aspect and catchment area features of the area to be irrigated for automatically ascertaining water retention at a plurality of different regions within the area to be irrigated; and

a computerized computing functionality employing the Topography Integrated Ground watEr Retention (TIGER) map together with at least current outputs of wetness sensors located at the plurality of different regions within the area to be irrigated to generate a current irrigation plan.

The invention further provides an automated Topography Integrated Ground watEr Retention (TIGER) map generating system comprising:

a data input interface receiving at least the following inputs:

a topographical input describing topographical features of an area to be irrigated; and

an electromagnetic input describing conductive features of the area to be irrigated,

computerized topographic feature processing functionality automatically deriving from the inputs, information relating to at least one of slope, aspect and catchment area features of the area to be irrigated; and

computerized topographic feature utilization functionality employing the at least one of slope, aspect and catchment area features of the area to be irrigated for automatically ascertaining water retention at a plurality of different regions within the area to be irrigated.

The invention also provides an automated soil type classification system comprising:

an input interface receiving:

offline pre-existing laboratory generated soil drying curves, which indicate at least the following parameters for a plurality of different types of soils: field capacity, wilting point and refill point; and

empirical field drying curves for a field for which irrigation is to be planned;

and a computer operated automatic correlator employing the offline pre-existing laboratory generated soil drying curves and the empirical field drying curves for a field for which irrigation is to be planned to automatically provide a soil type map for the field for which irrigation is to be planned.

The invention also provides a computerized differential irrigation system comprising:

a computerized Topography Integrated Ground watEr Retention (TIGER) map generator receiving at least the following inputs:

a topographical input describing topographical features of an area to be irrigated; and

an electromagnetic input describing conductive features of the area to be irrigated,

and in which the computerized Topography Integrated Ground watEr Retention (TIGER) map generator includes:

a computerized automatic soil type analysis functionality which obviates the need for laboratory testing of soil in the area to be irrigated.

The invention also provides a computerized irrigation efficiency metric generating system comprising:

a computerized Topography Integrated Ground watEr Retention (TIGER) map generator receiving at least the following inputs:

a topographical input describing topographical features of an area to be irrigated; and

an electromagnetic input describing conductive features of the area to be irrigated,

and in which the computerized Topography Integrated Ground watEr Retention (TIGER) map generator includes:

a computerized topographic feature processing functionality providing information relating to at least one of slope, aspect and catchment area features of the area to be irrigated; and

a computerized topographic feature utilization functionality employing the at least one of slope, aspect and catchment area features of the area to be irrigated for automatically ascertaining water retention at a plurality of different regions within the area to be irrigated; and

a computing functionality employing the Topography Integrated Ground watEr Retention (TIGER) map together with at least current outputs of wetness sensors located at the plurality of different regions within the area to be irrigated to generate a current irrigation plan; and

an irrigation efficiency analyzer operative to:

ascertain an amount of water required to irrigate the area based on the current irrigation plan;

ascertain an amount of water required to irrigate the area if differential irrigation is not employed; and

calculate an irrigation efficiency metric representing a water saving produced by employing the current irrigation plan.

The invention also provides methods of using any one of the described and/or claimed systems within the body of this disclosure.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of not only the listed components which the use directly references, but also to other non-specified components or elements.

This application is related to and claims priority from NZ Provisional Patent Application Serial No. NZ 603449, filed Nov. 6, 2012 and entitled Precision Irrigation Scheduling, the disclosure of which is hereby incorporated by reference.

### BRIEF DESCRIPTION OF THE DRAWINGS

The present invention will be understood and appreciated more fully from the following detailed description of the invention, taken in conjunction with the drawings in which:

FIG. 1 is a simplified schematic diagram, which provides an overview of a differential irrigation system constructed and operative in accordance with an embodiment of the present invention;

FIG. 2 is a simplified schematic diagram, which illustrates creation of a Topography Integrated Ground watEr Retention (TIGER) zone map in accordance with a preferred embodiment of the present invention;

FIG. 3 is a simplified schematic diagram, which illustrates operation of an automated soil type ascertaining process;

FIG. 4 is a simplified schematic diagram, which illustrates operation of an irrigation logic process;

FIG. 5 is a simplified schematic diagram, which illustrates an embodiment of the invention that controls a drip irrigation system; and

FIG. 6 is a simplified schematic diagram, which illustrates ascertaining an Irrigation Water Utilization Metric (IWUM) in accordance with a preferred embodiment of the present invention, which is useful in optimizing water pricing and allocation by a water provider.

FIG. 7, which is an example of the Topography Integrated Ground watEr Retention (TIGER) zone map 115 of FIG. 1. It is appreciated that the map comprises of three irrigation management zones. These correspond to soil physics and soil moisture data provide hereinabove, with reference to FIG. 2.

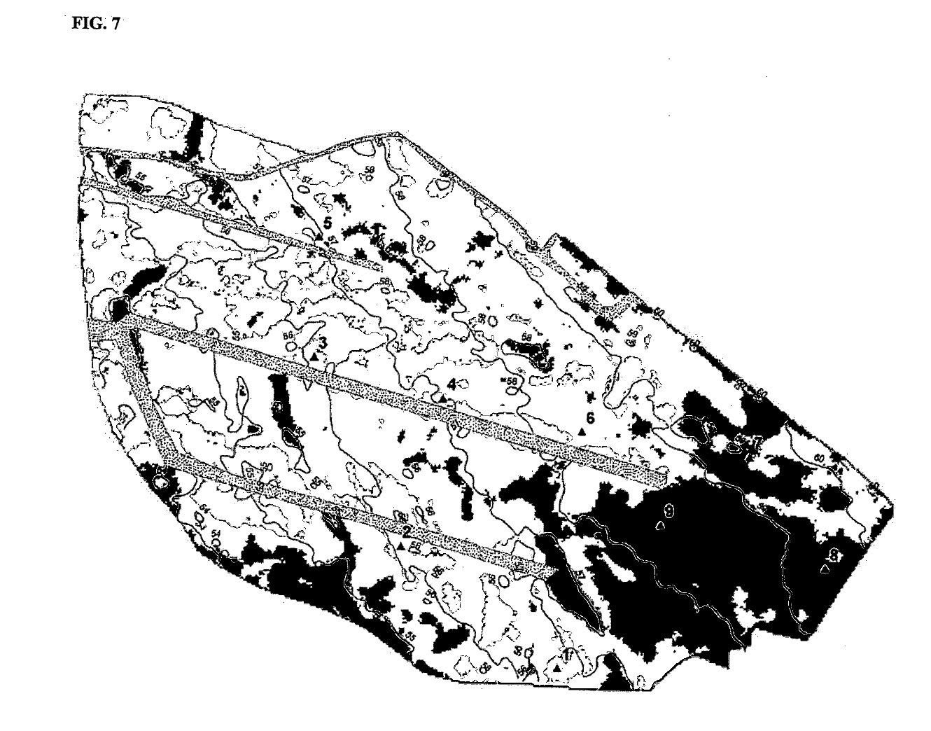

FIG. 8, which is an image of graphs of soil drying curves, illustrates results of the automated soil type ascertaining process 270 of FIG. 2. It is appreciated that the graphs depict a collection of soil drying curves; each line correlates to a specific sample (right plate). These samples are successfully trended and grouped into distinct soil class categories.

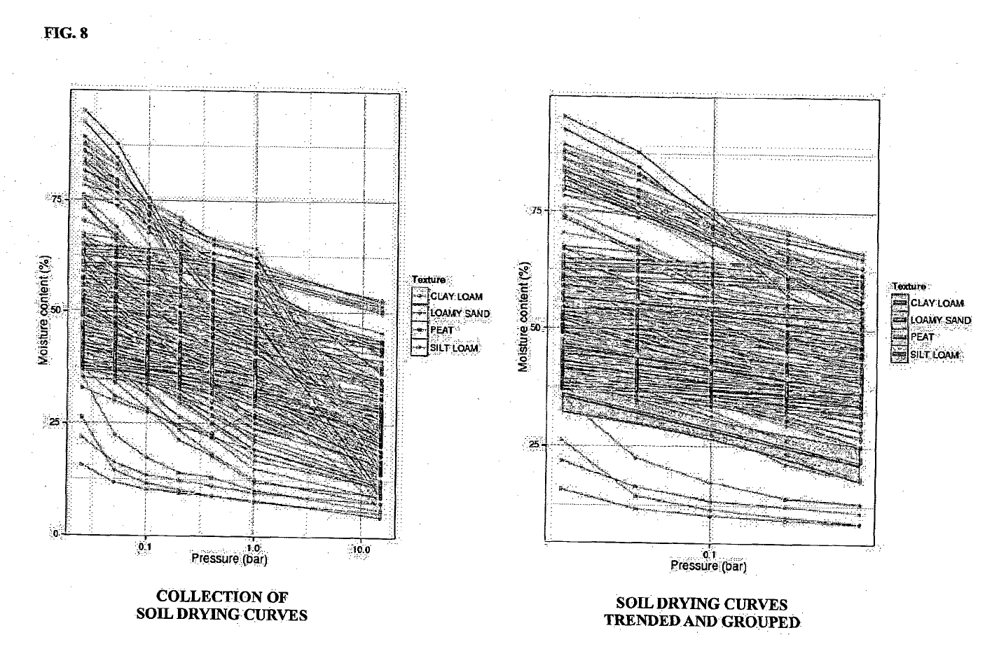

FIG. 9 is an image of screens of a mobile computing app, constructed and operated in accordance with a preferred embodiment of the present invention. The screen images of the software, demonstrate the full automation of the irrigation planning process. It is appreciated that without full automation, which is provided by the differential irrigator 100 of FIG. 1, such app and screens would not be possible. As an example, many factors, climatic, plant related, time related, and soil related, would need to be displayed to the user. The user would also need to view a much larger and more detailed map of the field 105, in order to consider how to irrigate. In contrast, the app shown provides the user with simplicity of automated use, which is similar to that of a ‘television remote control’, rather than that of complicated software. It is appreciated that this simplicity cannot be achieved without the automation of differential irrigation that the present invention offers.

### DETAILED DESCRIPTION OF PREFERRED EMBODIMENTS

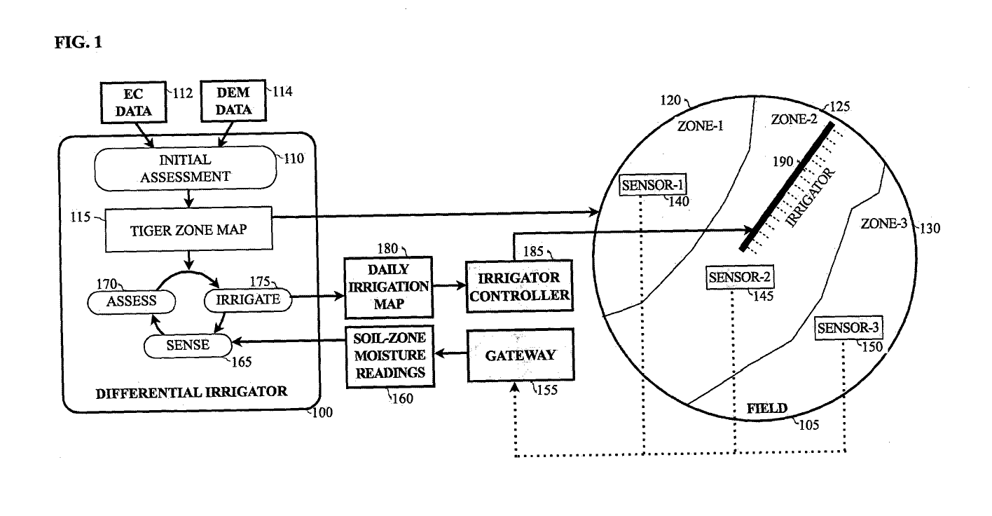

Reference is now made to FIG. 1, which is a simplified schematic diagram providing an overview of the present invention.

Irrigation planning for large fields, the process of deciding how much water to apply onto which part of a large field and when—is known in the art to be a complex process, and one which has never been successfully automated. The hardware required for such irrigation is available, and one example is known as Site-specific Variable Rate Irrigation (SS-VRI or VRI). But an automated process to maximize the value of such variable rate irrigation, or differential irrigation—at present doesn't exist. Much has been studied and known about the various factors affecting irrigation needs. But, the process of analyzing these various factors, for a specific field, crop and climate, and automatically transforming them into an effective automated irrigation plan, remains a process which until the present has defied automation, and requires site specific, manual, ongoing expert analysis.

A recent review Evans et. al, Review: Adoption of site-specific variable rate sprinkler irrigation systems (Irrig. Sci 2013), states, inter alia,: “The development of algorithms, sensor specifications, and placement criteria and decision support systems for SS-VRI is still in their infancy. General, broad-based, intuitive, and easily adjusted software (decision support) for implementation of prescriptions for SS-VRI systems is not available for a multitude of crops, climatic conditions, topography, and soil textures. The complexity in optimizing multi-objective, multivariate “(irrigation) prescriptions for dynamically changing management zones will be a substantial challenge for researchers, industry, and growers alike”.

In fact, the current process of planning differential irrigation is at present so far from automation and so dependent on skilled manual expertise, that the above review concludes, inter alia, that “specialized, continual training on the hardware, software, and advanced agronomic principles is needed now for growers, consultants, dealers, technicians, and other personnel on how to define management zones (areas), write prescriptions, and develop seasonal crop irrigation management guidelines. This has been slowed because the criteria for training individuals to develop management zones, write appropriate crop-specific prescriptions, and assist with the decision-making processes have yet to be defined.”

Current irrigation logic methodology tries to assess as many of the complex factors affecting irrigation, either using sensors to measure them, or models to predict them. These include crop factors (crop type and phase), climate factors (temperature, humidity, wind, etc.) and soil factors (soil type, soil water retention capacity, and soil moisture). The complexity of this information is such, that it cannot be automatically ‘resolved’ into an irrigation plan. Rather, the ‘raw’ information is then presented to the farmer who would consult it, and then manually decides how to irrigate.

This challenge is much greater in large fields. Irrigation-logic needs of small domestic gardens or vegetable patches may be adequately addressed by relatively simple soil-moisture sensors ‘closed-loop’ systems. Such systems simply use a soil moisture sensor and irrigate to replenish a desired soil-moisture threshold. But extending them to large fields would require dozens of soil-sensors under a single irrigator, often hundreds across a farm, which would be both cost prohibitive as well as would interferes with field cultivation, such as plowing.

The present inventors have realized that would be very useful if there was an accurate map charting the ‘water holding’ properties of a field (for example, clay retains more water than sand). If such a map existed, it would be possible to divide the field into effective irrigation zones, and monitor soil moisture in each of these zones, knowing that the same soil moisture is expected to be found everywhere within this zone. Irrigation could then be guided accordingly.

The accepted way of attempting to create such irrigation management zones, relies on Electro-Conductivity (EC) mapping, also referred to as Electro-Magnetic (EM) mapping, a procedure which measures the conductivity of soil and thereby gives an indication of its water content, and which is further described herein below.

The inventors earlier tried to develop such a reliable ‘water holding’ map of a field based on EC mapping, in order to guide irrigation - and they have failed. In their study (Hedley, AGWAT 2009) they created and tested the effectiveness of irrigation zones based directly on Electro-Conductivity mapping of a field, using the accepted methodologies for EC mapping and data analysis. They then installed 50 soil moisture sensors, 50 meters apart, in a grid across the 32 hectare field studied, expecting to prove that there is little variance between the soil moisture readings within each of three EC-based soil-zones. This would indicate that the zoning is effective, and mean that it is then possible to use a single sensor in a zone, and expect its measurements to reflect the soil moisture across the entire zone.

Unfortunately, the results indicated that in fact there was a significant variance between sensor readings within each of the EC-based zones, and little to no difference between the zones (mean and standard deviation (SD) were identical in two EC-based irrigation zones, and less than 1 SD different from the third zone, with % coefficient of variation (% CV) in all three zones ranging between 9% and 14%). This observation is further validated by the fact that there was little variance between multiple readings the same sensor over time, indicating that the- sensors themselves are reliable.

The present invention proposes a different method of producing a novel, reliable water retention potential map, referred to here as a Topography Integrated Ground watEr Retention (TIGER) map, and dividing it into effective irrigation management zones that accurately reflect water retention properties. This method is based on a novel computerized method of analysis and integration, which analyzes topographical terrain attributes, and integrates them with an analysis of EC mapping data. The Topography Integrated Ground watEr Retention (TIGER) zone map of the present invention for the first time, allows automation of the differential irrigation planning process, as illustrated in FIG. 1.

In accordance with a preferred embodiment of the present invention, a differential irrigator 100, which preferably is embodied in an automated irrigation decision support software module running on a general purpose computer, or on a mobile computing and or communication device in conjunction with an internet-based computing server, is used to enable efficient irrigation of a field 105, by differentially irrigating different parts of the field 105. It is typically the case that the soil composition and the topography of agricultural fields are not homogeneous, and hence different parts of the field often require different amounts of irrigation.

In accordance with a preferred embodiment of the present invention, the differential irrigator 100 preferably initially performs a one-time initial assessment 110 of the field 105, based at least in part on Electro-Conductivity Mapping Data, designated EC data 112 and topographical Digital Elevation Mapping Data, designated DEM data 114, both of the field 105. EC data is preferably obtained from EM mapping. EM mapping measures the apparent electrical conductivity of soil through the use of electromagnetic sensors that are towed on the surface soil of a field, typically by a quad bike, which is fitted with RTK GPS. The EM sensor uses a transmitting coil that induces a magnetic field that varies in strength according to soil depth.

A receiving coil reads primary and secondary induced currents in the soil. It is the relationship between these primary and secondary currents that measures soil conductivity. EM mapping may be performed using commercially available EM mapping hardware, such as Geomatrix' EM31 and EM38, data is processed into an EC map using publicly available software. It may also be obtained from service providers that provide both EM sensing service in the field, as well as processing the obtained data into an EC map. A recent report summarizes the current practices, and illustrates examples of suitable equipment, and service providers (‘Standards for Electromagnetic Induction mapping in the grains industry’, GRDC Precision Agriculture Manual, Australia 2006).

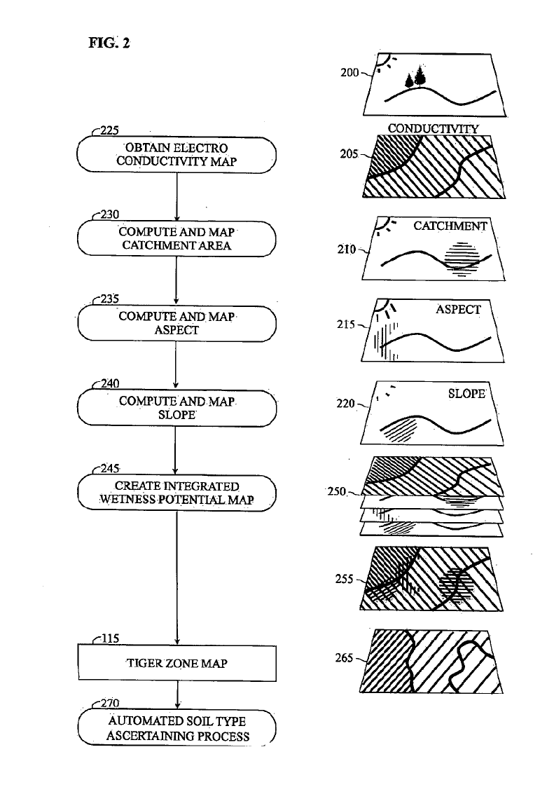

DEM data 114 may also be obtained from EM mapping output, since DEM data is typically collected as part of the EM survey, since EM survey is typically performed using a RTK GPS, which logs DEM data 115. It is important to note that DEM data 114 is unrelated to EC data, and is typically discarded in the prior art. Alternatively, DEM data 114 may be obtained from other sources of DEM data 114, including databases of DEM data 114, instruments that record DEM data 114 and services of DEM data 114 mapping. EC data 112 and DEM data 114 and the modes for obtaining them are further described herein below with reference to FIG. 2.

The initial assessment 110 generates a Topography Integrated Ground watEr Retention (TIGER) zone map 115, which preferably provides for each location in the field 105, a soil wetness potential score, reflecting relative ‘potential for retaining water’ of this location in the field 105, relative to all other locations therein. This soil wetness potential score is based on an analysis of EC data 112 and DEM data 114, and reflects a calculation of an integrated effect of physical soil properties, reflected in the EC data 112, and of topographical terrain attributes, which are calculated based an analysis of the DEM data 114), both of the field 105.

The Topography Integrated Ground watEr Retention (TIGER) zone map 115 preferably also divides the field 105 into several irrigation zones according to their soil wetness potential score. In a preferred embodiment of the present invention, the several irrigation zones, typically three irrigation zones, zone-1 120, zone-2 125 and zone-3 130. Each one of these irrigation zones preferably has soil-physics properties and topographical terrain attributes that indicate that it would retain water differently and hence require different amount and timings of irrigation from each one of the other irrigation zones.

The Topography Integrated Ground watEr Retention (TIGER) zone map 115 is preferably also used to define one or more suitable locations for placing one or more soil sensors within each of zone-1 120, zone-2 125 and zone-3 130. In a preferred embodiment of the present invention, sensor-1 140 is a sensor node, located within zone-1 120, sensor-2 145 is a sensor node located within zone-2 125, and sensor-3 150 is a sensor node located within zone-3 130.

In a preferred embodiment of the present invention, a location determined by the Topography Integrated Ground watEr Retention (TIGER) zone map 115 for sensor-1 140 is such that based at least in part on measurements of sensor-1 140, the differential irrigator 100 can effectively predict an irrigation condition of the entire zone-1 120. The same is true for sensor-2 145 and sensor-3 150 and their corresponding zone-2 125 and zone-3 130. Each of sensor-1 140, sensor-2 145 and sensor-3 150—is a sensor node that preferably comprises one or more sensors. In a preferred embodiment of the present invention, each sensor node may comprise two soil moisture sensors, installed at two different soil depths, depending on crop type. In a preferred embodiment of the present invention, each node also comprises a temperature sensor. The initial assessment 110 and the Topography Integrated Ground watEr Retention (TIGER) zone map 115 are further described herein below with reference to FIG. 2.

Sensor-1 140, sensor-2 145 and sensor-3 150 are preferably connected, preferably wirelessly, preferably via a gateway 155 to the differential irrigator 100. In a preferred embodiment of the present invention, other sensors, including but not limited to sensors operative to detect rainfall, climatic conditions, and plant parameters, may also be utilized and similarly connected to the differential irrigator 100; these are not required for operation of the present invention, but may be useful in improving its performance.

Once the installation described hereinabove is complete, the differential irrigator 100 preferably enables effective irrigation of the field 105, through the following iterative process.

A step designated SENSE 165, receives measurements from each of sensor-1 140, sensor-2 145 and sensor-3 150. These measurements preferably represent a soil moisture and an irrigation condition of zone-1 120, zone-2 125 and zone-3 130 respectively.

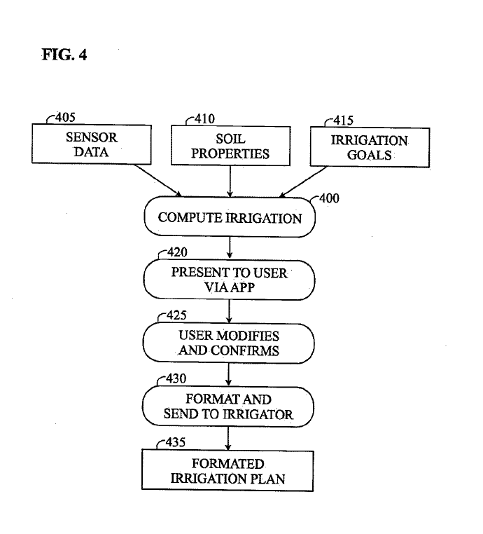

Next, a step designated ASSESS 170 assesses the measurements received from each of the sensor-1 140, sensor-2 145 and sensor-3 150. Based at least in part on these measurements, assess 170 determines an amount of irrigation appropriate for each of zone-1 120, zone-2 125 and zone-3 130, which amounts of irrigation may preferably be different from one another. Preferred operation of ASSESS 170 is further described hereinbelow with reference to FIG. 4.

Finally, a step designated IRRIGATE 175, preferably communicates a daily irrigation map 180 to an irrigator controller 185, which controls an irrigator 190. The irrigator 190 may preferably be a mechanized irrigation device, such as a pivot irrigator, a lateral move irrigator, or other. The irrigator 190 then irrigates the field 105 accordingly. Preferred operation of IRRIGATE 175 is further described hereinbelow with reference to FIG. 4.

In a preferred embodiment of the present invention, this iterative process of SENSE 165, ASSESS 170 and IRRIGATE 175, may be performed at scheduled intervals, such as daily. In other preferred embodiments of the present invention, it may take place following each irrigation event, or prior to each planned irrigation event, or upon demand of a user of the system.

Reference is now made to FIG. 2, which is a simplified schematic diagram illustrating the rationale and operation of the initial assessment 110 of FIG. 1, a process which is central to the present invention.

Reference numeral 200 designates a schematic image depicting a field to be irrigated which is non-flat topologically. Judging by its external appearance, it appears quite ‘normal’. Its vegetation appears quite uniform. It does not seem to be different from other fields, which have a similar external appearance. Current irrigation systems would irrigate a field like this uniformly, or at best—would base irrigation exclusively on EC data 112. The present invention takes a different approach, through an appreciation that EC data 112 is not the only factor affecting the wetness of the ground and takes into account topographic terrain attributes, which significantly influence soil water retention and hence irrigation. Harnessing an analysis of these various features produces the Topography Integrated Ground watEr Retention (TIGER) zone map 115, which enables automation of differential irrigation planning. These topographic terrain attributes and the method by which they are analyzed and integrated with the EC data are further described herein below.

Reference numeral 205 designates a schematic image depicting an EC map of the field of schematic image 200, showing EC-based irrigation management zones. While the field of 200 seems ‘normal’, underlying it is the EC data, which indicates different soil zones.

Reference numeral 210 designates a schematic image depicting catchment area mapping of the field of image 200. A catchment area is an area that is topographically lower than its surroundings, the soil of which tends to be more ‘soggy’.

Reference numeral 215 designates a schematic image depicting ‘aspect mapping’ of the field of image 200: Aspect mapping indicates the extent of exposure to the sun and utilizes the fact that areas that are facing the sun, receive more solar radiation and hence dry up more rapidly than those that don't.

Reference numeral 220 designates an schematic image depicting ‘slope mapping’ of the field of image 200 and utilizes the fact that areas that have a steeper slope retain water differently than ones of moderate slopes. It is appreciated from schematic images 205-220 that there are multiple factors affecting the water-retention properties of the field of 200.

Reference numeral 225 designates a schematic image depicting the superimposition of the four above mentioned datasets: EC mapping 205, catchment mapping 210, aspect mapping 215 and slope mapping 220. In accordance with a preferred embodiment of the present invention at least one and preferably all of the aforesaid mappings are integrated into a single coherent map, the Topography Integrated Ground watEr Retention (TIGER) map.

As noted above, reference numeral 205 depicts an Electro Conductivity (EC) map of the same field, divided into three irrigation zones, based on the EC data. EC data may be derived from Electro-Magnetic (EM) mapping. EM mapping is acquired using EM sensors, such as Geonics EM38Mk2 and EM31 sensors, which are preferably combined with RTK-DGPS and dataloggers mounted on an all-terrain vehicle to acquire high resolution EM38 and EM31 vertical mode datasets in two separate surveys. A Trimble Ag170 field computer may be used for simultaneous acquisition of high resolution positional and ECa data.

The sensors preferably measure a weighted mean average value for apparent electrical conductivity (EC) to 1.5 m depth (EM38) and 5.0 m depth (EM31). Survey data points are preferably collected at 1-s intervals, at an average speed of 15 kph, with a measurement recorded approximately every 4 m along transects 10 m apart. Filtered data comprising latitude, longitude, height above mean sea level and ECa (mSm⁻¹) may preferably be imported into ArcGIS (Environmental Systems Research Institute, (ESRI© 1999). Points are preferably kriged in Geostatistical Analyst (ESRI© 1999) using a spherical semivariogram and ordinary kriging to produce a soil ECa prediction surface map. Three management zones may preferably be defined on this map (using Jenks natural breaks) for further soil sampling. EM surveys quantify soil variability largely on a basis of soil texture and moisture in non-saline conditions.

A process designated compute and map catchment area 230 computes a catchment layer 210, which is a spatial representation of the Catchment Area value of every point in the field 105. A catchment area is defined as the In(a/tan β) where is the local upslope area draining through a certain point per unit contour length and tan β is the local slope. A location has a high catchment area value when it is topographically depressed relative to its surrounding area. Accordingly, a soil in a location which has a high catchment area value tends to retain more water and be ‘more soggy’. As an example, water would more likely accumulate at the bottom of a valley than at the top of a hill. There are various methods to compute catchment.

In a preferred embodiment of the present invention the surface and subsurface runoff is parameterized by catchment area estimations. The catchment area (CA), defined as the discharge contributing upslope area of each grid cell and the specific catchment area, defined as the corresponding drainage area per unit contour width are computed using the multiple flow direction method of FREEMAN (1991).

In another preferred embodiment the SAGA Wetness Index is used in conjunction with the Topographic Wetness Index (TWI). SWI is similar to TWI but it is based on a modified catchment area calculation (out.mod.carea), which does not treat the flow as a thin film as done in the calculation of catchment areas in conventional algorithms. As a result, the SWI tends to assign a more realistic, higher potential soil wetness than the TWI to grid cells situated in valley floors with a small vertical distance to a channel. A computer code is then preferably used to integrate the different predictors, remove sinks, and correct for overlapping results. The computer code performing the calculation of catchment area, in a way that has been found effective in predicting irrigation management zones and is enclosed as computer code listing.

A process designated compute and map aspect 235 computes the aspect layer 215, which is a spatial representation of a set of ‘aspect’ values of every point in the field 105. By aspect, is meant in which direction the land is facing. As an example, land facing the sun, will dry faster and hence require more water than land facing away from the sun. A process designated compute and map slope 240 computes the aspect layer 220, which is a spatial representation of the slope in value in degrees of every point in the field 105. As an example, steeper sloped land will require a different amount of water than flatter land. Computer code performing the calculation of slop and of aspect, in a way that has been found effective in predicting irrigation management zones and is enclosed as computer code listing.

Having calculated the above mentioned four datasets, conductivity score map 205, catchment score map 210, aspect score map 215 and slope score map 220, the next step is create the Topography Integrated Ground watEr Retention (TIGER) map. It is appreciated that each one of these maps on its own is not useful for guiding irrigation. It is further appreciated, as images 250 and 255 illustrate, that simply overlying these maps one on top of the other, is similarly not useful. The following algorithm and methodology is preferably used in order to carefully analyze each data point in each of these datasets, integrating them to generate an integrated wetness potential map 115.

It is appreciated that each of the above datasets 205-220 is a map of the field 105, wherein each location in this map of the field 105 is associated with a value. As an example, the catchment score map 210 comprises a catchment score for each point in the map. Same is true for the EC value map, aspect score value map and slope value map. To integrate these scores, a large set of vectors is created, corresponding to all locations in the field 105 which are investigated, for example all locations for which EC data 112 and DEM data 114 has been obtained. This set of vectors is designated vector pool. Each vector preferably comprises eight attributes: a location property (its location within the field 105, preferably an x location and a y location, and a set of six measured or calculated attributes, relating to the above mentioned four data sets: superficial EC score, deep EC score, catchment score, aspect score, slope score, and elevation (as per DEM data 114 for that location). Importantly, elevation is not associated with soil wetness, but has been found to be an important attribute, useful in creating the integrated wetness potential map 115, as described herein below.

A number of vectors are randomly selected. Each of these serves as a nuclei of an integrated wetness potential score zone. In a preferred embodiment of the present invention, the number of initial tentative nuclei is preferably 100, providing a detailed map of the integrated wetness potential scores in the field 105. In another preferred embodiment, the number of initial nuclei is preferably a much smaller number: a desired number of irrigation zones, typically 3 or 4. In yet another preferred embodiment, the number may be double the number of the desired irrigation zones, so as to have within each irrigation zone an ‘inner zone’, in which the sensors are to be placed, so that sensors are placed in a location which best represents the irrigation zone they are in.

Each vector in the vector pool is assessed for its distance to the each of the nuclei, and added to the closest nuclei. By distance is meant an integrated distance, that is a distance which takes into account the distance of each attribute of the vector to that attribute in each of the nuclei. In a preferred embodiment of the present invention, this distance may preferably be calculated as a squared error function.

When all vectors in the pool have been thus assigned to nuclei, the barycenter of each nucleus is calculated, and the process of assessing each vector in the vector pool to a nucleus and assigning it to the nearest nucleus is repeated. With each iteration, the centre of the nuclei of each further optimized. This process is repeated until the location of the centre of the nuclei does not move between iteration. In a preferred embodiment of the present invention, the process is preferably repeated 1000 iterations.

In a preferred embodiment of the present invention, a function describing the calculation performed in evaluating the integrated affect of each location in each of the conductivity score map 205, catchment score map 210, aspect score map 215 and slope score map 220—on each corresponding location the integrated wetness potential map 115—may be described calculated as follows:

$$J = {\sum }_{j = 1}^{k} {\sum }_{i = 1}^{k} {‖ {x}_{i}^{( j )} - {c}_{j} ‖}^{2}$$

where K is the number of zones, N is number of vectors (i.e. locations evaluated in the field 105), X is an attribute, and i is the type of attribute.

It is appreciated that topographical terrain attributes other than the ones listed above may be used to calculate the integrated wetness potential map 115, and that the above mentioned ones are provided as an example only and are not meant to be limiting. It is further appreciated that the above description of methodology of integrating topographical terrain attributes and EC data may be performed using other methodologies, and that the above methodology is provided as an example only and is not meant to be limiting.

The Topography Integrated Ground watEr Retention (TIGER) zone map 115, and the irrigations zones therein, may preferably be represented in suitable formats, including but not limited to polygons and shape-files. Conversion into such formats is well known in the art, for example using a ‘Raster-to-Polygons’ and ‘Polygon-to-Shapefile’ in ‘R’ Programming language (www.r-proJect.org). Such formats are useful for comparing the irrigation zones to other data and for communicating with irrigation system controllers and other agricultural systems.

According to a preferred embodiment of the present invention, if more than one crop is grown in the field 105 under the same irrigator 190, than the irrigation zones may preferably divided into soil-crop zones, such that there is only one crop per irrigation zone. As an example, if there are two crops, wheat and corn, grown within single soil-topography irrigation zone ‘A’, then this zone ‘A’ would preferably be divided into zone ‘A-Wheat’ and zone ‘A-Corn’. This, since the water uptake and hence irrigation balance of these two crops may be different, and hence would require separate sensors monitoring them, and separate irrigation planning logic.

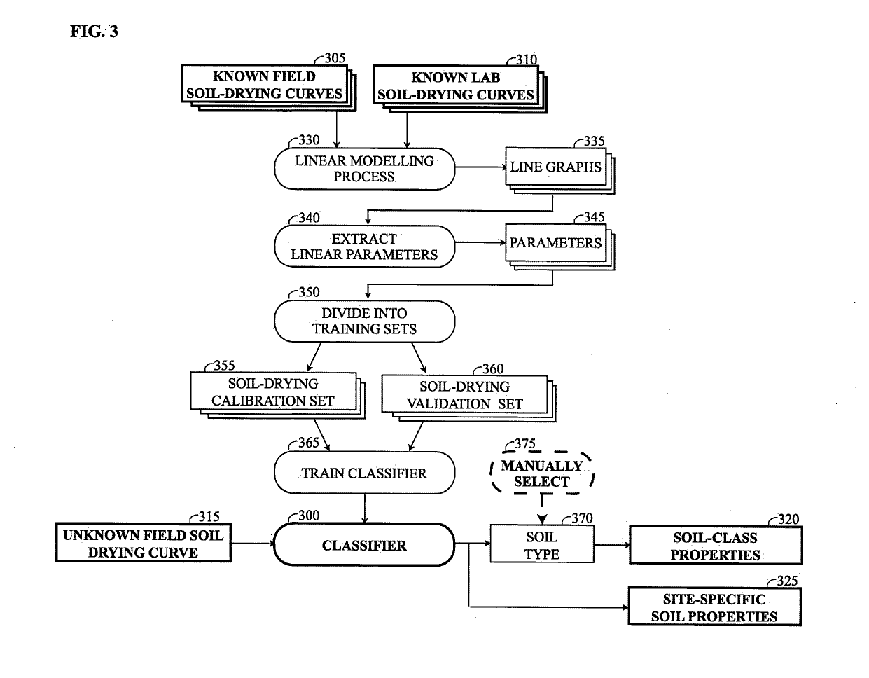

Lastly, for each of the irrigation zones determined in the Topography Integrated Ground watEr Retention (TIGER) zone map 115, a soil type is determined, by a process designated an automated soil type ascertaining process 270, which is further described herein below, with reference to FIG. 3.

Accuracy of the the initial assessment 110 and Topography Integrated Ground watEr Retention (TIGER) zone map 115 both of FIG. 1 was validated in the field as follows. Three replicate soil samples (at three depth intervals) were randomly collected from each of the three classes identified from the Topography Integrated Ground watEr Retention (TIGER) zone map 115, avoiding spray truck and irrigator tracks. The soil samples were intact soil cores (100 mm diameter and 80 mm in height) taken from the middle of three sample depths (0-200 mm, 200-400 mm, 400-600 mm) for laboratory characterisation of bulk density and soil moisture release characteristics (at 10 kPa); and smaller cores (50 mm diameter and 20 mm in height) were taken for soil moisture release at 100 kPa. A bag of loose soil was also collected (0-200 mm, 200-400 mm, 400-600 mm soil depth) for laboratory estimation of permanent wilting point (1500 kPa) (Burt, 2004) and particle size distribution. Total available water holding capacity (AWC) was estimated as the difference between volumetric soil moisture content (mcv) at 10 kPa and 1500 kPa, where 10 kPa is taken as field capacity and 1500 kPa is wilting point. Readily available water holding capacity (RAWC) was estimated as the difference between mcv at 10 kPa and at 100 kPa. Percent sand, silt and clay was determined on these soil samples by organic matter removal, clay dispersion and wet sieving the >2-mm soil fraction and then by a standard pipette method for the <2-mm soil fraction (Claydon, 1989).

Table 1 summarizes some significant measured differences between the soil hydraulic characteristics of the three classes identified from the Topography Integrated Ground watEr Retention (TIGER) zone map 115 of FIG. 1. These measured differences reflect differences in pore size distribution and justify the efficacy of the Topography Integrated Ground watEr Retention (TIGER) zone map 115, as the basis for management of irrigation. An increasing Available Water Capacity (AWC) with class number reflects an increasing proportion of pores in the range where plant-available water is stored, in particular readily available water which is stored between 10 kPa and 100 kPa (pore size diameters 0.03-0.003 mm).

TABLE 1
Soil texture and hydraulic characteristics (±standard deviation) of
soils in the three management classes

| | Soil moisture release at | | | | | | |
|---|---|---|---|---|---|---|---|
| | 10 kPa | 100 kPa | 1500 kPa | RAWC* | AWC* | Sand | Clay |
| Class | m³m⁻³ | m³m⁻³ | m³m⁻³ | m³m⁻³ | m³m⁻³ | % | % |
| 1 | 0.11 ± 0.02 | 0.06 ± 0.01 | 0.03 ± 0.00 | 0.05 ± 0.02 | 0.08 ± 0.02 | 96 | 2 |
| 2 | 0.14 ± 0.04 | 0.09 ± 0.01 | 0.03 ± 0.01 | 0.05 ± 0.04 | 0.11 ± 0.04 | 95 | 2 |
| 3 | 0.24 ± 0.02 | 0.13 ± 0.02 | 0.04 ± 0.00 | 0.11 ± 0.03 | 0.20 ± 0.02 | 90 | 4 |

*RAWC = readily available water-holding capacity; AWC = available water-holding capacity.

The soil moisture sensors used also tracked large differences in soil moisture between soil classes within this study area (FIG. 2), reflecting their contrasting soil moisture release characteristics, and the varying influence of a high water table, especially noticeable in Class 3 soils. Prior to commencement of irrigation in late spring 2010, the soil moisture sensors simultaneously monitored 0.11±0.06 m³ m⁻³ in the dry classes (lowest EC values) compared with 0.17±0.26 m³ m⁻³ (intermediate EC classes) and 0.27±0.64 m³ m⁻³ in the wettest classes (highest EC values). The dry classes (Class 1 in FIG. 1) hold less available water and require irrigation sooner than Class 3.

For the period: February-March 2011, the depth to water table varied at any one time by about 70 cm (FIG. 2). A 66 mm rainfall event between 4th and 6th March caused the water table to rise by about 50 cm in Class 1 and 70 cm in Class 3 (FIG. 2). This difference is due to different storage capacities of the soils and landscape position. Class 3 soils occupy low-lying areas where water tends to accumulate by overland runoff and lateral flow, and the water table is closest to the surface. These soils, typically being wetter, require less rainfall to bring them to saturation; and once saturated the water table rises to the surface, at a faster rate than in soils starting at a drier soil moisture content.

Continuous soil moisture sensor recordings, at 15 minute intervals during an entire irrigation season, from a network of 9 sensors, placed in the different irrigation zones defined by the Topography Integrated Ground watEr Retention (TIGER) zone map 115, provided an unprecedented high resolution temporal dataset, confirming the efficacy of the Topography Integrated Ground watEr Retention (TIGER) zone map 115 and providing important input for its fine-tuning.

In another preferred embodiment of the present invention, predictive modelling of an underground water table may be useful, preferably using a random forest regression trees data mining algorithm (R F, Breiman, 2001). This approach and experiments validating its are useful is described as follows. The use of EM38, EM31, digital elevation and rainfall data were investigated for incorporating into the predictive models. Rainfall data was obtained from the closest weather station (six kilometres away), and rainfall was assumed constant over the study area at any one time. TWI and SWI were extracted from the digital elevation map (see 2.3). The data was fused by projecting it onto a common grid, and modelling the co-variates in space. Two predictive modelling approaches were developed and compared to explain observed patterns of water table depth and soil moisture status, i.e. a simple approach using multiple linear regression (MLM), and a data-mining approach using random forest regression trees (R F, Breiman, 2001).

Three predictors have been selected to dynamically model soil moisture content and water table depth: EM38, SWI and rainfall. EM38 and SWI data have been log-transformed to overcome skewness, as modelling approaches assume normal distribution. The rainfall data have been integrated over three days to account for the time required for the rain event to fully affect water table depth. These variables were selected as the best predictors, and other attributes, including elevation, EM31 and TWI, although tested, did not improve model predictions, and were therefore not included, with our objective being to develop the best parsimonious prediction model.

Reference is now made to FIG. 3, which is a simplified schematic diagram illustrating operation of automated soil type ascertaining process 270.

As is known in the art, different types of soils have different water release properties. For example, clay retains water well, whereas sand does not. These soil water release properties are typically studied in the lab, for example by taking intact soil core samples, drying them under lab conditions, and recording the release of water from the soil over time, also known as a soil-drying curve. Such curves are useful in guiding irrigation. Of special importance are three points that are on the curve and are derived from it. Field Capacity is the maximal amount of water which the soil can retain without runoff. At Wilting Point plants will wilt. And Refill Point, which is calculated based on these two, represents the level of water in the soil, below which irrigation is needed.

Refill Point and Field Capacity are useful in controlling irrigation; since a goal of efficient irrigation is preferably to maintain a soil moisture level that is in the range between these two. A severe limitation of existing irrigation solutions is that these values can currently only be obtained through a manual scientific laboratory process, which is therefore expensive. Importantly, it also prevents automation of the irrigation planning process.

The automated soil type ascertaining process 270 is a novel automated process to determine the soil type of irrigation zones in the field 105, without requiring a manual laboratory process. This process is preferably an automated process which trains a classifier 300, using a set of known field soil-drying curves 305 and preferably a set of known lab soil-drying curves 305. Once trained, the classifier 300 is operative to analyze an unknown Field soil-drying curve and determine its soil-class properties 320, or its site specific soil properties 325, as further explained herein below.

The classifier 300 is preferably embodied in machine learning computer software. In a preferred embodiment of the present invention the classifier 300 may preferably be a Decision Tree algorithm. It is appreciated however that there are many powerful, easily applicable machine learning methodologies, algorithms and tools known in the art, and the following embodiment described is provided as an example only and is not meant to be limiting.

Each one of the known Field soil-drying curves 305, is a set of soil-moisture measurements along a time axis, made in the field, by a soil-moisture sensor, in a soil type. These measurements may be plotted as a soil drying curve. The set of known Field soil-drying curves 305 comprises of a plurality of such soil drying curves, from each of a plurality of locations and soil types.

Similarly, each one of the known lab soil-drying curves 305, is a set of soil-moisture measurements along a time axis, but ones which were made in the laboratory, where the water content in the soil is accurately measured by weighing the soil sample as it is being dried in an oven. The set of known lab soil-drying curves 305 comprises of a plurality of such sets of moisture measurements, or soil drying curves, taken from each of a plurality of locations and soil types. Preferably, as least part of the known Field soil-drying curves 305 and the known lab soil-drying curves 310 are taken from an identical location and soil type.

In a preferred embodiment of the present invention, a linear modeling process 330 fits the known Field soil-drying curves 305 and the known lab soil-drying curves 310 to corresponding plurality of line graphs 335. For each of the line graphs 335, an extract LINEAR parameters 340 process is performed, which derives parameters 345, preferably an Intercept and a Slope of each of the line graphs 335. The parameters 345 are a convenient abstraction of each of the known Field soil-drying curves 305 and the known lab soil-drying curves 310. It is appreciated that the classifier 300 may be trained on curves directly using various methodologies well known in the art, and may also be trained on abstractions or models other than the linear modeling process 330, which is provided as an example only.

In a preferred embodiment of the present invention, a divide into training sets 350 process, divides the parameters 345 derived from the known Field soil-drying curves 305 into two datasets: a soil-drying calibration set 355 and a soil-drying validation set 360. In another preferred embodiment of the present invention, the parameters 345 derived from the known lab soil-drying curves 310 are similarly divided into these two datasets.

The train classifier 365 process uses the soil drying calibration set 355 and the soil drying validation set 360, to train the classifier 300. The classifier 300 is trained to identify patterns which appear in the soil-drying calibration set 355, and then tests its success in identifying these patterns, on the soil drying validation set 360. In a preferred embodiment, the soil drying calibration set 355 and the soil drying validation set 360 may preferably be grouped by their soil type, and or by other criteria, and the classifier 300 may be trained to identify a drying curve, or its abstraction, which typifies this drying curve in the soil type.

Various methodologies are known in the art to train machine learning classifiers and other comparable software algorithms. These include, but are not limited to: an iterative process of training and validation, processes in which the training and validation sets are dynamically changed and overlap, and other methodologies. It is appreciated therefore that the description herein of the training of the classifier 300 are simplified and provided as an example only and are not meant to be limiting.

Once trained, the classifier 300 is operative to analyze an unknown Field soil-drying curve 315 and based on this analysis to determine a soil type 370 to which the unknown Field soil-drying curve 315 corresponds. By soil-class, is meant soil type of a ‘class’ of soils, such as ‘clay’, ‘sand’, ‘sandy-loam’ etc. It is understood, that as an example, soil in two different farms may be classified as ‘sandy loam’ in both, although there may be a difference between the ‘sandy loam’ of one, compared to the other.

In various preferred embodiments of the present invention a list of 8-12 of following soil types, is preferably used, and their Field Capacity and Wilting Point values may preferably be used (v %):

| Texture | Capacity | Wilting |
|---|---|---|
| Sand | 10 | 5 |
| Loamy sand | 12 | 5 |
| Sandy loam | 18 | 8 |
| Sandy clay loam | 27 | 17 |
| Loam | 28 | 14 |
| Sandy clay | 36 | 25 |
| Silt loam | 31 | 11 |
| Silt | 30 | 6 |
| Clay loam | 36 | 22 |
| Silty clay loam | 38 | 22 |
| Silty clay | 41 | 27 |
| Clay | 42 | 30 |

In another preferred embodiment of the present invention, the classifier 300 determines SITE-SPECIFIC soil properties 325 of the unknown Field soil-drying curve 315. As mentioned above, grouping soils into ‘classes’ such as ‘Clay loam’ etc., is a generalization, whereas in fact the soil in each site has its own specific water retention properties. These are referred to here as SITE-SPECIFIC soil properties 325.

As is known in the art, the accuracy, sensitivity and specificity of a machine learning classifier depends on the size and quality of the training and validation sets and on the quality of the unknown sample to be analysed. The accuracy of the classifier 300 increases over time, as it continues to be trained by the train classifier 365. Its increasing accuracy over time is further facilitated by two factors. First, the known Field soil-drying curves 305 is constantly growing, as more users use the system. This, since the system continuously streams all readings from all sensors of all users to its central data repository, and thus accumulates a growing number of soil-drying curves, obtained from various soil types. Second, over time, the readings from a specific irrigation zone in a specific farm also accumulate. Over time, therefore, the unknown Field soil-drying curve 315, rather than being a single curve, may preferably be a plurality of soil-drying curves obtained from the same location. Providing as input such a plurality of ‘natural variants’ of the sample to be identified greatly increases the accuracy of a classifier, as is well known in the art.

According to another preferred embodiment of the present invention, the soil type 370 may be obtained by the farmer-user manually selecting a type of soil, as designated by manually select 375. The differential irrigator 100 may preferably be implemented as a computer-web application or more preferably as mobile-web application, wherein clear guidelines describe the differences between preferably 8-12 types of soil. Preferably, short videos and photographs guide the farmer in selecting the correct type of soil-class.

Reference is now made to FIG. 4, which is a simplified schematic diagram illustrating operation of ASSESS 170 and IRRIGATE 175, both of FIG. 1.

A compute irrigation process 400 preferably receives as input, sensor data 405, soil properties 410 and irrigation goal 415. The sensor data 405 comprises readings received from soil moisture and other sensors, such as sensor-1 140, sensor-2 145 and sensor-3 150 all of FIG. 1. The soil properties 410, comprises soil-class properties 320 and site-specific soil properties 325 both of FIG. 3, including field capacity and refill point properties. The irrigation goals 415 preferably comprises user defined guidelines, indicating up to which soil moisture level the user would like to irrigate, preferably relative to the field capacity and refill point values of the soil of the zone in which the sensor is located. In a preferred embodiment of the present invention, the user may provide as one of the irrigation goals 415, a percentage number, relating to the range between refill point and field capacity. Irrigation goals 415 may comprise global irrigation goals and crop specific irrigation goals.

The compute irrigation 400 compares each sensor reading received, with the soil propertied of the soil of the irrigation zone, and the irrigation goal defined by the user, and calculates accordingly the recommended irrigation for that zone.

Next step, present to user via app 420, preferably presents a tentative irrigation map, for each of the zones of the field 105 of FIG. 1, preferably via an app on a mobile device, or a computer, or a web browsing device.

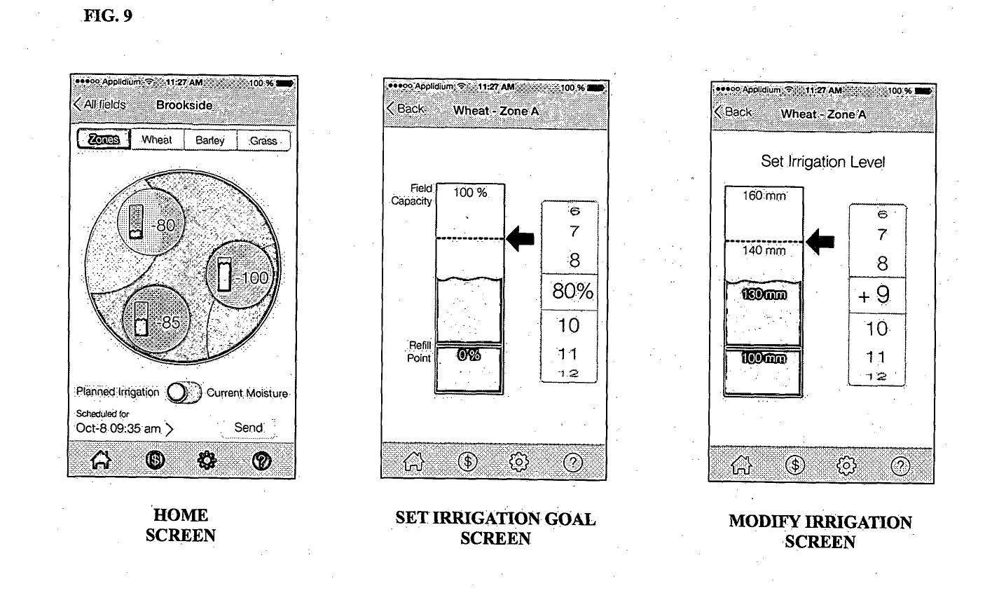

A step designated user modifies and confirms 425 allows the user to review the irrigation recommendation, and very simply modify it. In a preferred embodiment of the present invention, this modification may be performed via the mobile app, preferably using under 4 or less clicks and or gestures, in most cases. FIG. 9 presents several screen layouts of an app constructed and operative in accordance with a preferred embodiment of the present invention, illustrating the total automation, and simplicity and ease of use, with which steps present to user via app 420 and user modifies and confirms 425, are preformed.

Format and send to irrigator 430 illustrates operation of IRRIGATE 175 of FIG. 1. This process formats the irrigation map approved by the user in the previous step, in to a formatted irrigation plan 435, such that it is suitable for the irrigator controller 185 and the irrigator to the irrigator 190. It is appreciated that there are different types, brands and providers of mechanical irrigators, such as pivot irrigators and lateral move irrigators. As an example, the format and send irrigator 430 may format formatted irrigation map 435 as a ‘full-VRI’ map (that is, where every point in the field may receive a different amount of irrigation), or to pivot speed or section control irrigator (that is, where different sectors of a circular field, receive different amounts of irrigation), for section or speed control of lateral move irrigator (that is, where different cross-sections of a rectangular field receive different amounts of irrigation. In another preferred embodiment of the present invention, the format and sent to irrigator 430 may provide an amount to irrigate, to be applied uniformly onto a field, such that the irrigation is optimized based on the assessment of the irrigation needs of each part of the field, and preferably one or more user preferences. This step also formats the irrigation map to the technical format, suitable for a specific vendor of an irrigator 190 or irrigator controller 185.

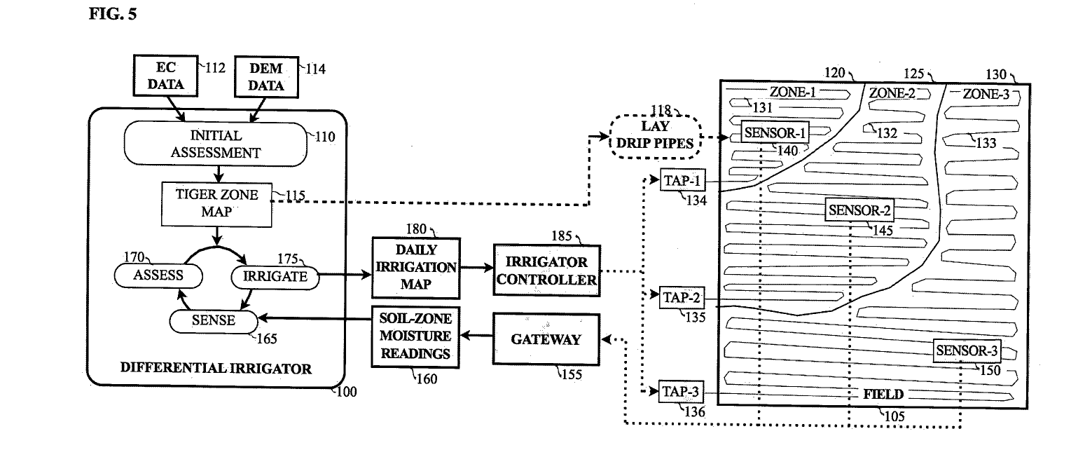

Reference is now made to FIG. 5, which is a simplified schematic diagram illustrating embodiment of the invention that guides a drip irrigation system.

In accordance with another preferred embodiment of the present invention, the differential irrigator 100 of FIG. 1 may automatically control differential irrigation of the field 105, through use of a drip irrigation system.

In this embodiment, the Topography Integrated Ground watEr Retention (TIGER) zone map 115 preferably also defines a pattern for laying drip irrigation pipes, such that a separate drip irrigation pipe is placed in each of the irrigation zones, zone-1 120, zone-2 125 and zone-3 130. This pattern for laying drip irrigation pipes allows a farmer to LAY DRIP PIPES 118 accordingly: a pipe designated zone-1-PIPE 131 in zone-1 120, a pipe designated zone-2-PIPE 132 in zone-2 125, and a pipe designated zone-3-PIPE 133 in zone-3 130.

Each of the three pipes preferably connect to a corresponding tap: zone-1-PIPE 131 connects to TAP-1 134, zone-2-PIPE 132 connects to TAP-2 135, zone-3-PIPE 133 connects to TAP-3 136.

In a preferred embodiment of the present invention, TAP-1 134, TAP-2 135 and TAP-3 136 are remotely operated taps, preferably controlled by the irrigator controller 185.

Similar to the process described hereinabove with reference to FIG. 1, the differential irrigator 100 operates in an automated iterative manner: sense 165 receives measurements from each of sensor-1 140, sensor-2 145 and sensor-3 150, assess 170 assesses these measurements and determines an amount of irrigation appropriate for each of zone-1 120, zone-2 125 and zone-3 130, which amounts of irrigation may preferably be different from one another. Lastly, irrigate 175, preferably communicates the daily irrigation map 180 of FIG. 1 to the irrigator controller 185, which in turn controls TAP-1 134, TAP-2 135 and TAP-3 136, thereby delivering suitable irrigation amounts to each of zone-1 120, zone-2 125 and zone-3 130.

As mentioned hereinabove with reference to FIG. 1, in a preferred embodiment of the present invention, this iterative process of sense 165, assess 170 and irrigate 175, may be performed on scheduled intervals, such as daily. In other preferred embodiments of the present invention, it may take place following each irrigation event, or prior to each planned irrigation event, or upon demand of a user of the system.

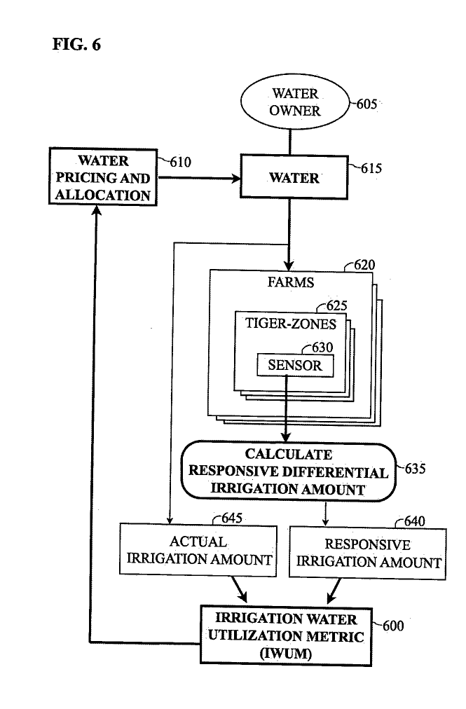

Reference is now mad to FIG. 6, which illustrates ascertaining an Irrigation Water Utilization Metric (IWUM) in accordance with a preferred embodiment of the present invention, which is useful in optimizing water pricing and allocation by a water provider.

Uniform irrigation, which is the current norm, is often wasteful, since different parts of a field often have different irrigation needs. The damages from this are waste of water, reduced crop due to overwatering, and damage to ground water reservoirs through chemical leaching and waste overflow. Water owners and governments bear much of this consequence, since water provided to agriculture is often heavily subsidized or discounted. Governments and state agencies further suffer from this, by means of damage to the state's natural resources.

It would be advantageous for water owners, governments and state agencies, to have tools which allow monitoring of the efficiency with which water is used for irrigation. An important aspect of this would be a tool which monitors and grades the differential irrigation efficiency, that is to what extent irrigation of a field is optimized for the different needs of different parts of a field. Currently such tool does not exist. The present invention provides such a tool, which is described herein below.

The present invention provides a Irrigation Water Utilization Metric (IWUM) 600, which empowers a water owner 605 to affect a water pricing and allocation 610 of water 615 that the water owner 605 provides to each of a plurality of farms 620.

Each of the plurality of farms 620 may comprise a plurality of Topographic Integrated Ground watEr Retention zones, designated TIGER zones 625, which are derived from the Topographic Integrated Ground watEr Retention zone map designated Topography Integrated Ground watEr Retention (TIGER) zone map 115 of FIG. 1. The differential irrigator 100 of FIG. 1 is operative to analyze and determine an amount of irrigation each of the TIGER zones 625, needs at any time, if suitable sensors are installed in each of these zones.

According to a preferred embodiment of the present invention, one or more sensor 630 is preferably installed in each of the TIGER zones 625. The sensor is preferably a soil moisture sensor node, similar to sensor-1 140, sensor-2 145 and sensor-3 150 of FIG. 1, and preferably comprises two soil moisture sensors installed at two soil depths.

Using mechanisms described hereinabove with reference to FIGS. 1-4, a calculate responsive differential irrigation amount 635, may calculate a responsive irrigation amount 640 based on input from one or more sensor 630, from each of the plurality of sensor-zones 625, for any one of the farms 620. By comparing the responsive irrigation amount 640 (that is: calculating how much water would have been irrigated, if this farm would have irrigated differentially and effectively) to an actual irrigation amount 645 (that is the amount of water that this farm actually used)—the Irrigation Water Utilization Metric (IWUM) 600 is calculated. As an example, the Irrigation Water Utilization Metric (IWUM) 600 may be a ratio between the responsive irrigation amount 640 and the actual irrigation amount 645.

The Irrigation Water Utilization Metric (IWUM) 600 may then be used by a water owner 605, to affect the water allocation and pricing 610 of the water 615 provided to this one of the farms 620. It is appreciated that the Irrigation Water Utilization Metric (IWUM) 600 may be used by the water owner 605 as well as by other interested parties, in various ways, and in combination with various other elements, to govern the use of water, encourage water savings, and for other purposes, and that the above description is meant as an example only and is not meant to be limiting.

### Computer Program Listing

The following sections of a computer code used in a preferred embodiment of the present invention, may be useful for understanding of the invention. It is appreciated the following computer code sections are provided as an example only and are not meant to be limiting.

### INDUSTRIAL APPLICABILITY

The invention will be useful in the areas of irrigation of any type of pasture, crop or other agricultural environment where irrigation of land is required.

The invention provides and exemplifies a system and a method for reducing the amount of water required to irrigate an area of land, by applying different amounts of water to different parts of the field, based at least in part on an analysis of spatial soil properties of the field including topological features, and extrapolation of data from soil sensors placed in different parts of a field.

The invention thus provides a useful system and method for irrigating land in an environmentally friendly manner.

1. A computerized differential irrigation system comprising:
a computerized Topography Integrated Ground watEr Retention (TIGER) map generator receiving at least the following inputs:
an input describing topographical features of an area to be irrigated; and
an input describing physical soil properties of the area to be irrigated,
and in which the computerized Topography Integrated Ground watEr Retention (TIGER) map generator includes:
a computerized topographic feature processing functionality providing information relating to at least one of slope, aspect and catchment area features of said area to be irrigated; and
a computerized topographic feature utilization functionality employing at least one of slope, aspect and catchment area features of the area to be irrigated for automatically ascertaining water retention at a plurality of different regions within the area to be irrigated; and
a computerized computing functionality employing the Topography Integrated Ground watEr Retention (TIGER) map together with at least current outputs of wetness sensors located at the plurality of different regions within the area to be irrigated to generate a current irrigation plan; and
a computerized irrigation control subsystem automatically utilizing the current irrigation map to control irrigation within the area to be irrigated based on the current irrigation instructions and to cause different amounts of water to be provided to the different regions within the area to be irrigated.

2. A computerized differential irrigation system according to claim 1 and in which the computerized Topography Integrated Ground watEr Retention (TIGER) map generator employs automatically generated soil type data.

3. A computerized differential irrigation system according to claim 1 and in which the computerized Topography Integrated Ground watEr Retention (TIGER) map generator includes a computerized automatic soil type analysis functionality which obviates the need for laboratory testing of soil in the area to be irrigated.

4. A method of using a computerized system according to claim 1 by
ascertaining an amount of water required to irrigate said area based on said current irrigation plan;
ascertaining an amount of water required to irrigate said area if differential irrigation is not employed; and
calculating an irrigation efficiency metric representing a water savings produced by employing the current irrigation plan.

5. A method according to claim 4 and also comprising employing the irrigation efficiency metric for at least one of controlling supply and pricing of water and mandating irrigation policy.

6. A computerized irrigation planning system comprising:
a computerized Topography Integrated Ground watEr Retention (TIGER) map generator receiving at least the following inputs:
an input describing topographical features of an area to be irrigated; and
an input describing physical soil properties of the area to be irrigated,
and in which the computerized Topography Integrated Ground watEr Retention (TIGER) map generator includes:
a computerized topographic feature processing functionality providing information relating to at least one of slope, aspect and catchment area features of the area to be irrigated; and
a computerized topographic feature utilization functionality employing the at least one of slope, aspect and catchment area features of the area to be irrigated for automatically ascertaining water retention at a plurality of different regions within the area to be irrigated; and
a computerized computing functionality employing the Topography Integrated Ground watEr Retention (TIGER) map together with at least current outputs of wetness sensors located at the plurality of different regions within the area to be irrigated to generate a current irrigation plan.

7. A computerized system according to claim 6 and wherein the computerized Topography Integrated Ground watEr Retention (TIGER) map generator employs automatically generated soil type data.

8. A computerized system according to claim 6 and wherein the computerized Topography Integrated Ground watEr Retention (TIGER) map generator includes computerized automatic soil type analysis functionality which obviates the need for laboratory testing of soil in the area to be irrigated.

9. A method of using a computerized system according to claim 6, to generate an irrigation plan obviating the need for laboratory testing of soil in the area to be irrigated.

10. An automated Topography Integrated Ground watEr Retention (TIGER) map generating system comprising:
a data input interface receiving at least the following inputs:
an input describing topographical features of an area to be irrigated; and
an input describing physical soil properties of the area to be irrigated,
computerized topographic feature processing functionality automatically deriving from the inputs, information relating to at least one of slope, aspect and catchment area features of the area to be irrigated; and
computerized topographic feature utilization functionality employing the at least one of slope, aspect and catchment area features of the area to be irrigated for automatically ascertaining water retention at a plurality of different regions within the area to be irrigated.

11. A computerized system according to claim 10 and wherein the computerized Topography Integrated Ground watEr Retention (TIGER) map generating system also employs automatically generated soil type data which is input at the data input interface.

12. A computerized system according to claim 10 and wherein the computerized Topography Integrated Ground watEr Retention (TIGER) map generating system includes computerized automatic soil type analysis functionality which obviates the need for laboratory testing of soil in the area to be irrigated.

13. A method of using a computerized system according to claim 10 by:
ascertaining an amount of water required to irrigate the area based on the current irrigation plan;
ascertaining an amount of water required to irrigate the area if differential irrigation is not employed; and
calculating an irrigation efficiency metric representing a water savings produced by employing the current irrigation plan.

14. A method according to claim 13 and wherein the irrigation efficiency metric is employed for at least one of controlling supply and pricing of water and mandating irrigation policy.

15-17. (canceled)

18. A computerized differential irrigation system comprising:
an computerized Topography Integrated Ground watEr Retention (TIGER) map generator receiving at least the following inputs:
a input describing topographical features of an area to be irrigated; and
an input describing physical soil properties of the area to be irrigated,
and in which the computerized Topography Integrated Ground watEr Retention (TIGER) map generator includes:
a computerized automatic soil type analysis functionality which obviates the need for laboratory testing of soil in the area to be irrigated.

19. A computerized system according to claim 18 and wherein the computerized Topography Integrated Ground watEr Retention (TIGER) map generating system also employs automatically generated soil type data which is input at the data input interface.

20. A computerized system according to claim 18 and wherein the computerized Topography Integrated Ground watEr Retention (TIGER) map generating system includes computerized automatic soil type analysis functionality which obviates the need for laboratory testing of soil in the area to be irrigated.

21. A method of using a computerized system according to claim 18 and also:
ascertaining an amount of water required to irrigate the area based on the current irrigation plan;
ascertaining an amount of water required to irrigate the area if differential irrigation is not employed; and
calculating an irrigation efficiency metric representing a water savings produced by employing the current irrigation plan.

22. A method according to claim 21 and also comprising employing the irrigation efficiency metric for at least one of controlling supply and pricing of water and mandating irrigation policy.

23. A computerized irrigation efficiency metric generating system comprising:
a computerized Topography Integrated Ground watEr Retention (TIGER) map generator receiving at least the following inputs:
an input describing topographical features of an area to be irrigated; and
an input describing physical soil properties of the area to be irrigated,
and in which the computerized Topography Integrated Ground watEr Retention (TIGER) map generator includes:
a computerized topographic feature processing functionality providing information relating to at least one of slope, aspect and catchment area features of the area to be irrigated; and
a computerized topographic feature utilization functionality employing the at least one of slope, aspect and catchment area features of the area to be irrigated for automatically ascertaining water retention at a plurality of different regions within the area to be irrigated; and
a computing functionality employing the Topography Integrated Ground watEr Retention (TIGER) map together with at least current outputs of wetness sensors located at the plurality of different regions within the area to be irrigated to generate a current irrigation plan; and
an irrigation efficiency analyzer operative to:
ascertain an amount of water required to irrigate the area based on the current irrigation plan; ascertain an amount of water required to irrigate the area if differential irrigation is not employed; and
calculate an irrigation efficiency metric representing a water saving produced by employing the current irrigation plan.

24-29. (canceled)
